(19) United States
(12) Patent Application Publication
(10) Pub. No.: US 2010/0080590 A1
(43) Pub. Date: Apr. 1, 2010

(54) IMAGE FORMING APPARATUS

(75) Inventor: Satoshi Takahashi, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/541,689

(22) Filed: Aug. 14, 2009

(30) Foreign Application Priority Data
Sep. 30, 2008 (JP) 2008-253861
May 28, 2009 (JP) 2009-129102

(51) Int. Cl. G03G 15/00; G03G 15/20

(52) U.S. Cl. 399/45; 399/69; 399/334; 399/389; 399/81

(57) ABSTRACT

An image forming apparatus comprising an image forming unit that forms an image on a sheet, a sheet feeder that feeds the sheet to the image forming unit, a detector that detects a width of the sheet, a setting unit that is operated by a user to input a width and a length of a nonstandard-size sheet, a determination unit that determines whether the width of the nonstandard-size sheet detected by the detector and the width of the nonstandard-size sheet inputted by the user to the setting unit differ from each other, when the image is printed on the nonstandard-size sheet and a controller that controls the image forming unit to form the image, based on the width of the sheet detected by the detector and the length of the sheet inputted by the user to the setting unit, when the determination unit determines that the detected width and the inputted width differ from each other.

### INCORPORATION BY REFERENCE

This application is based upon and claims the benefit of priority from the corresponding Japanese Patent application No. 2008-253861 filed Sep. 30, 2008 and No. 2009-129102 filed May 28, 2009, the entire contents of which are incorporated herein by reference.

### BACKGROUND

1. Field of the Invention

The present invention relates to image forming apparatuses, and in particular to an image forming apparatus capable of forming images on sheets having different sizes.

2. Description of the Related Art

Recent image forming apparatuses form images on sheets having standard sizes such as A4 and B5. These image forming apparatuses can also form images on sheets having nonstandard sizes. Sheets having nonstandard sizes include sheets having sizes other than the standard sizes such as A4, and B5. For example, an A4-size sheet has dimensions of 210 mm (width) by 297 mm (length), whereas a nonstandard-size sheet has dimensions of 180 mm (width) by 297 mm (length); accordingly, a little smaller than the A4-size sheet.

If a user wants an image to be formed on a nonstandard-size sheet, the size of the sheet to be used is in general set by the user. Specifically, the user sets the width and the length of the sheet. In such an image forming apparatus, an image is formed using the size set by the user.

However, for example, a user who is unaccustomed to the operation of the image forming apparatus may set an incorrect sheet size that is different from the actual sheet size.

A known image forming apparatus includes a sensor that detects the sheet size. If the size detected by the sensor and the size set by the user is different, the decision of which size is to be used for image formation is left to the user. In such a situation, if the user gives an instruction to form an image with the size set by the user, the interior of the image forming apparatus may be contaminated by toner or the like, or the temperature of certain areas of the fixing roller may inappropriately increase.

In another known image apparatus including a sensor that detects the sheet size, to form an image on a sheet having a nonstandard size, the sensor detects which of the standard sizes corresponds to the nonstandard size. If the detected standard size does not correspond to the nonstandard size set by the user, the image is formed using image formation conditions for the detected standard size. In such a situation, the image is formed on a sheet having the nonstandard size, but using the image formation conditions for the standard size. This may prevent the formation of an appropriate image.

### SUMMARY

The present invention provides image forming apparatus capable of forming an appropriate image matching the actual sheet size and having a long operational life and methods of using same.

An image forming apparatus according to an embodiment of the present invention comprises an image forming unit that forms an image on a sheet, a sheet feeder that feeds the sheet to the image forming unit, a detector that detects a width of the sheet, a setting unit that is operated by a user to input a width and a length of a nonstandard-size sheet, a determination unit that determines whether the width of the nonstandard-size sheet detected by the detector and the width of the nonstandard-size sheet inputted by the user to the setting unit differ from each other, when the image is printed on the nonstandard-size sheet and a controller that controls the image forming unit to form the image, based on the width of the sheet detected by the detector and the length of the sheet inputted by the user to the setting unit, when the determination unit determines that the widths differ from each other.

Additional features and advantages are described herein, and will be apparent from the following Detailed Description and the figures.

### BRIEF DESCRIPTION OF THE FIGURES

In the accompanying drawings:

FIG. 1 is a block diagram of a digital multifunction peripheral, to which an image forming apparatus according to an embodiment of the present invention is applied;

FIG. 2 is a schematic diagram illustrating a sheet feeder and an image forming section included in the digital multifunction peripheral according to an embodiment of the present invention;

FIG. 3 is a perspective view of a detector according to an embodiment of the present invention;

FIG. 4 is an enlarged view of a fixing unit according to an embodiment of the present invention;

FIG. 5 is a diagram illustrating a situation where an image is to be fixed onto a large sheet in an embodiment of the present invention;

FIG. 6 is a diagram illustrating a situation where an image is to be fixed onto a small sheet in an embodiment of the present invention; and

FIG. 7 is a flowchart illustrating a process of image formation performed by the digital multifunction peripheral according to an embodiment of the present invention.

### DETAILED DESCRIPTION

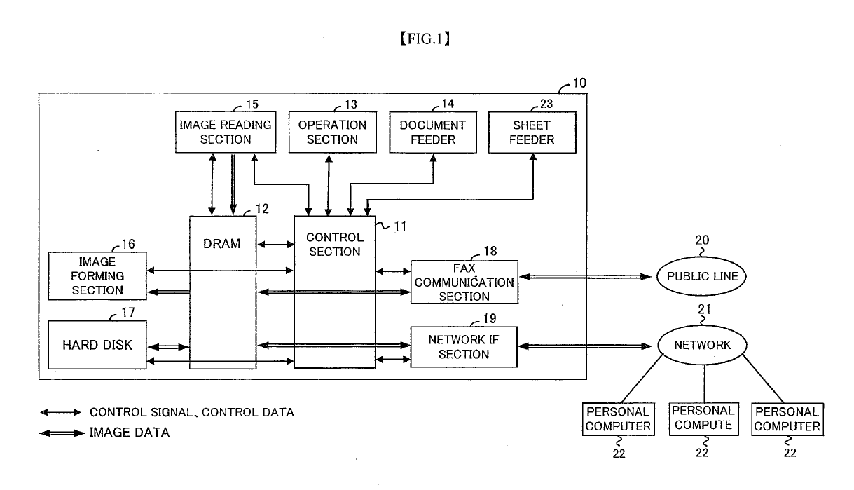

Embodiments of the present invention will now be described with reference to the drawings. FIG. 1 is a block diagram of a digital multifunction peripheral 10, to which an image forming apparatus according to an embodiment of the present invention is applied. Referring to FIG. 1, the digital multifunction peripheral 10 includes a control section 11 that controls the entirety of the digital multifunction peripheral 10, a dynamic random access memory (DRAM) 12 that writes and reads image data and the like, and an operation section 13 having a display screen on which information stored in the digital multifunction peripheral 10 is displayed and serving as an interface between the digital multifunction peripheral 10 and a user. A document feeder 14 is provided that automatically feeds a document to a predetermined document scanning position. An image reading section 15 is provided that scans at the predetermined scanning position the image of the document fed thereto by the document feeder 14, as well as an image forming section 16 that forms the image of the document or the like scanned by the image reading section 15 and outputs the image onto a sheet. A hard disk 17 stores image data and the like. A facsimile (FAX) communication section 18 is connected to a public line 20. A network interface (IF) section 19 is provided that provides the connection to a network 21. And a sheet feeder 23 is provided that feeds the sheet to the image forming section 16.

The control section 11 compresses and encodes document data supplied from the image reading section 15 and writes the encoded data into the DRAM 12. Subsequently, the control section 11 reads the data written in the DRAM 12 and, after decompressing and decoding the data, outputs the decoded data to the image forming section 16.

The digital multifunction peripheral 10 operates such that the image forming section 16 forms, via the DRAM 12, an image of the document scanned by the image reading section 15, thereby operating as a copier. The digital multifunction peripheral 10 also receives via the network IF section 19 image data sent from a personal computer 22 connected to the network 21 and then operates such that the image forming section 16 forms, via the DRAM 12, an image based on the image data, thereby operating as a printer. The digital multifunction peripheral 10 also receives, via the FAX communication section 18, image data sent thereto over the public line 20 and operates such that the image forming section 16 forms, via the DRAM 12, an image based on the image data, thereby operating as a facsimile. The digital multifunction peripheral 10 also sends image data of a document scanned by the image reading section 15 over the public line 20 via the FAX communication section 18. In short, the digital multifunction peripheral 10 has multiple functions relating to image processing, including a copier function, a printer function, a FAX function, and so forth. In addition, the digital multifunction peripheral 10 has various functions for setting the details of the foregoing functions.

In FIG. 1, the double-line arrows indicate the flow of image data and the single-line arrows indicate the flow of control signals and control data.

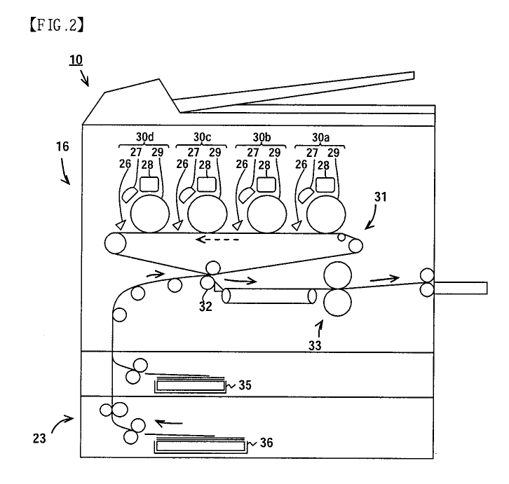

FIG. 2 is a schematic diagram illustrating the sheet feeder 23 and the image forming section 16 included in the digital multifunction peripheral 10 according to an embodiment of the present invention. In FIG. 2, the solid-line arrows indicate the direction in which the sheet is fed and the dashed-line arrow indicates the direction in which a transfer belt 31 rotates.

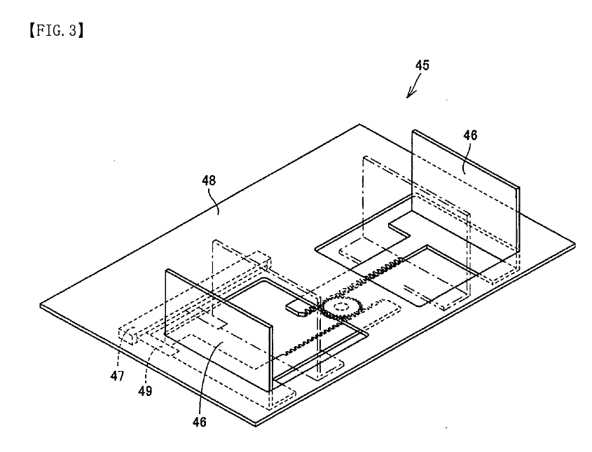

Referring to FIGS. 1 and 2, the sheet feeder 23 will first be described. The sheet feeder 23 includes first and second sheet cassettes 35 and 36 wherein the sheets are housed. The sheets are stacked on tables 48 (see FIG. 3) provided, respectively, in the first and second sheet cassettes 35 and 36.

The first sheet cassette 35 houses standard-size sheets, such as A4 and B5. The second sheet cassette 36 houses sheets that cannot be housed in the first sheet cassette 35, i.e., nonstandard-size sheets. Nonstandard-size sheets include sheets of any sizes other than standard sizes including A4, B5, and the like. For example, an A4-size sheet has dimensions of 210 mm (width) by 297 mm (length), whereas a nonstandard-size sheet has dimensions of 180 mm (width) by 297 mm (length); accordingly, a little smaller than the A4-size sheet.

The first and second sheet cassettes 35 and 36 each include a detector 45 that detects the width of the sheet. FIG. 3 is a perspective view of the detector 45 according to an embodiment of the present invention. Referring to FIG. 3, the detector 45 is provided in each of the first and second sheet cassettes 35 and 36. The detector 45 includes a pair of cursors 46 that move so as to match the width of sheets housed in the corresponding sheet cassette. This thereby regulates the widthwise position of the sheets. A variable resistor 47 is provided below the table 48, having a resistance that changes in conjunction with the movement of the pair of cursors 46. The detector 45 detects the width of the sheets.

The pair of cursors 46 have a rack-and-pinion mechanism. Specifically, when one of the pair of cursors 46 moves so as to match the width of the sheets housed in the corresponding sheet cassette, the other moves together in a direction either toward or away from each other. In this manner, the widthwise position of the sheets is regulated. In FIG. 3, the alternate long and short dashed lines represent the pair of cursors 46 that have moved toward each other. The resistance of the variable resistor 47 changes in conjunction with the movement of one of the pair of cursors 46, with the aid of a link member 49 interposed therebetween. The detector 45 reads the resistance of the variable resistor 47 and detects the width of the sheets housed in the corresponding sheet cassette.

For the second sheet cassette 36, the width and the length of sheets housed therein is inputted by the user to the operation section 13. In this situation, the operation section 13 functions as a setting unit.

The image forming section 16 will now be described. The image forming section 16 includes developers 30a to 30d provided for the colors yellow, magenta, cyan, and black, respectively. With respect to the developer 30a provided for yellow, the developer 30a includes a photoreceptor 29, a charger 26, an exposure unit 27, and a developing unit 28.

In the image forming section 16, the charger 26 first charges the surface of the photoreceptor 29 with a predetermined potential. Then the exposure unit 27 exposes the surface of the photoreceptor 29 to an optical image for yellow, whereby an electrostatic latent image is formed on the surface of the photoreceptor 29. Then, the developing unit 28 applies yellow toner to the electrostatic latent image, whereby a yellow toner image is formed on the surface of the photoreceptor 29. The developers 30b to 30d for magenta, cyan, and black have the same configuration as the developer 30a and form toner images having the respective colors on the surfaces of the respective photoreceptors 29. The toner images of yellow, magenta, cyan, and black are superposed on one another in that order on the transfer belt 31 shown in FIG. 2 and are subjected to a primary transfer, whereby a color image created by the images of yellow, magenta, cyan, and black is formed on the transfer belt 31. The transfer belt 31 rotates in the direction indicated by the dashed-line arrow.

Further, in the image forming section 16, the image on the transfer belt 31 is subjected to a secondary transfer, by using a transfer roller 32, onto a sheet fed from the first or second sheet cassette 35 or 36 in the sheet feeder 23. Then, the image transferred onto the sheet is fixed, by a fixing unit 33. In this manner, the image forming section 16 forms an image on a sheet. In this situation, the image forming section 16 functions as an image forming unit.

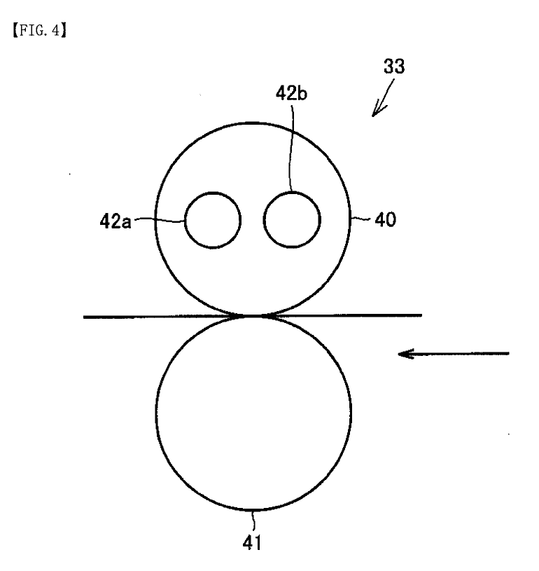

FIG. 4 is an enlarged view of the fixing unit 33 according to an embodiment of the present invention. In FIG. 4, the solid-line arrow indicates the direction in which the sheet is fed. Referring to FIG. 4, the fixing unit 33 includes a fixing roller 40 that fixes an image onto a sheet and a pressing roller 41 that opposes the fixing roller 40. The fixing roller 40 includes a first heater 42a and a second heater 42b. The first heater 42a heats a part of an area of the fixing roller 40, specifically, a central area (in the longitudinal direction thereof) of the fixing roller 40. In this situation, the first heater 42a operates as a first heating unit. The second heater 42b heats a larger area of the fixing roller 40 than the central area, specifically, the entirety (in the longitudinal direction thereof) of the fixing roller 40. In this situation, the second heater 42b functions as a second heating unit.

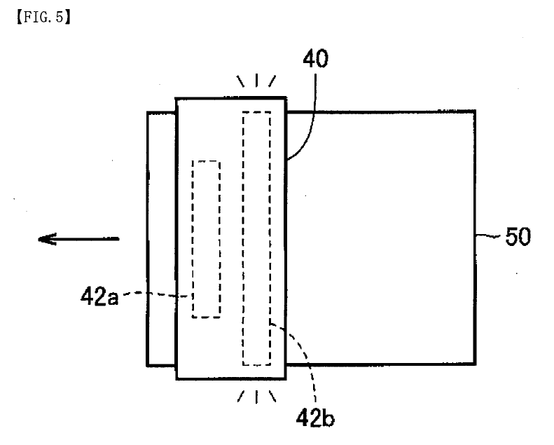

The fixing unit 33 controls where the fixing roller 40 is heated, by switching between the heaters 42a and 42b based on the width of the sheet on which an image is to be formed. Specifically, for A4 size of 210 mm (width) by 297 mm (length) as a threshold, when an image is to be formed on a large sheet of 230 mm (width) by 297 mm (length), the second heater 42b is turned on, and the entirety of the fixing roller 40 in the longitudinal direction thereof is heated. In this state, the sheet is made to pass on the fixing roller 40 in its longitudinal direction whereby the image is fixed onto the sheet. FIG. 5 is a diagram illustrating a situation where the image is to be fixed onto a large sheet 50. In FIG. 5, the dashed lines represent the first and second heaters 42a and 42b, and the solid-line arrow indicates the direction in which the large sheet 50 is fed.

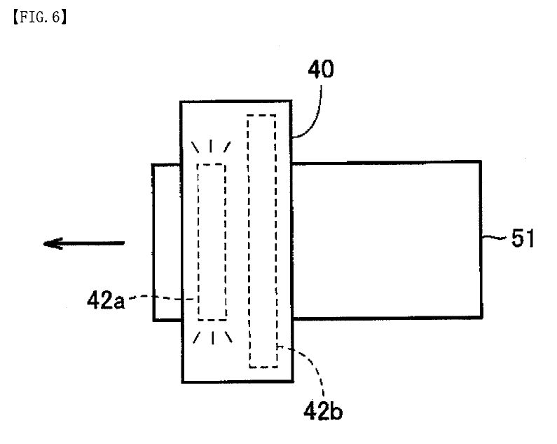

When an image is to be formed on a small-size sheet having, for example, dimensions of 150 mm (width) by 297 mm (length), the first heater 42a of the fixing unit 33 is turned on, causing the central area (in the longitudinal direction thereof) of the fixing roller 40 to be heated. In this state, the sheet is made to pass on the fixing roller 40 in its longitudinal direction, whereby the image is fixed onto the sheet. FIG. 6 is a diagram illustrating a situation where an image is to be fixed onto a small sheet 51. In FIG. 6, the dashed lines represent the first and second heaters 42a and 42b, and the solid-line arrow indicates the direction in which the small sheet 51 is fed.

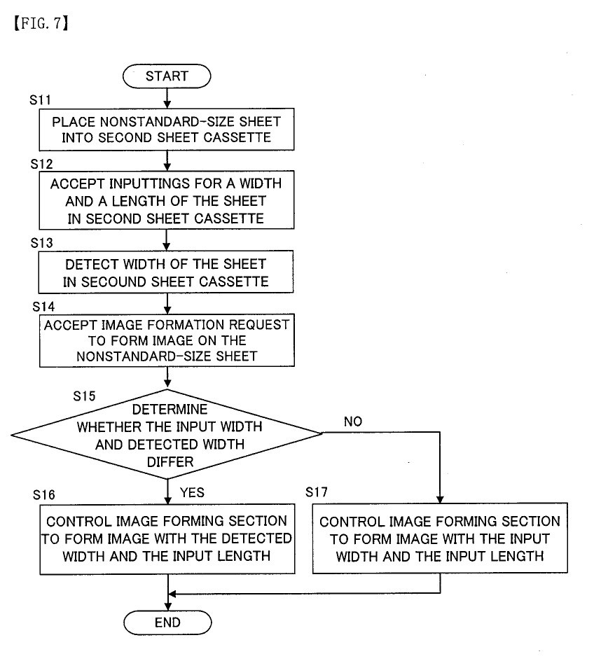

FIG. 7 is a flowchart illustrating a process whereby image formation is performed by the digital multifunction peripheral 10 according to an embodiment of the present invention. Referring to FIG. 7, the process of image formation performed by the digital multifunction peripheral 10 will now be described.

First, in step S 11 of FIG. 7, nonstandard-size sheets are placed in the second sheet cassette 36. Then, in step S12, the operation section 13 accepts the inputting of the size, or the width and the length, for the sheets placed in the second sheet cassette 36.

In step S13, the detector 45 detects the width of the sheets placed in the second sheet cassette 36 in step S11.

In step S14, the control section 11 accepts an image formation request so that an image is formed on each of the nonstandard-size sheets placed in the second sheet cassette 36 in step S11.

In step S15, the control section 11 determines whether the width inputted in step S12 and the width detected in step S13 differ from each other. In this step, the control section 11 operates as a determination unit. In other words, the determination unit determines whether the width of the nonstandard-size sheet detected by the detector and the width of the nonstandard-size sheet inputted by the user differ from each other, when the image is printed on the nonstandard-size sheet. Here, by way of example, the inputted width is 230 mm and the detected width is 150 mm. In this situation, the control section 11 determines that the two widths differ from each other (YES in step S15).

Then, in step S16, the control section 11 controls the image forming section 16 to form the image using the length inputted in step S12 and the width detected in step S13. Specifically, in the image forming section 16, electrostatic latent images having the detected width and the inputted length are formed on the surfaces of the photoreceptors 29, respectively, and toners of respective colors are applied to the electrostatic latent images, whereby toner images of the respective colors are formed. Further, in the fixing unit 33, the first heater 42a is only turned on, whereby the central area (in the longitudinal direction thereof) of the fixing roller 40 is heated. In short, the control section 11 controls the heating state of the fixing roller 40 using the first and second heaters 42a and 42b, based on the detected width of the sheet. In this step, the control section 11 functions as a controller. In other words, the controller controls the image forming unit to form the image, based on the width of the sheet detected by the detector and the length of the sheet inputted by the user to the setting unit, when the determination unit determines that the width of the nonstandard-size sheet differ from each other. Additionally, the controller controls the heating state of the fixing roller using the first and second heating unit, based on the width of the sheet detected by the detector.

When it is determined that the detected width of the sheet and the inputted width of the sheet differ from each other, the digital multifunction peripheral 10 controls, in step S16, its operation to form the image with the detected width. Thus, an image matching the actual width of the sheet can be formed. In this manner, the interior of the digital multifunction peripheral 10 is prevented from being contaminated by toner and the like, and the temperature of the fixing roller 40 outside the area where the sheet passes is prevented from increasing. Accordingly, an appropriate image matching the actual sheet size can be formed and a long operational life can be provided.

In step S15, when it is determined that the inputted width of the sheet and the detected width of the sheet are the same (NO in step S15), the digital multifunction peripheral 10 controls, in step S17, the image forming section 16 to form the image with the inputted width of the sheet.

The above embodiment concerns the situation where the range in which an image is to be formed and the heating state of the fixing roller 40 using the first and second heaters 42a and 42b are controlled based on the detected width of the sheet. However, the present invention is not limited to such an embodiment. That is, controlling only the heating of the fixing roller 40 using the first and second heaters 42a and 42b. Alternatively, the range in which an image is to be formed may only be controlled.

The above embodiment concerns the situation where the detector 45 includes the variable resistor 47 and the width of the sheets in the sheet cassette is detected by reading the resistance of the variable resistor 47. However, the present invention is not limited to such an embodiment. Instead, a leaf spring may be, for example, provided in the sheet cassette. In that situation, the width of the sheets in the sheet cassette may be detected by checking whether or not the leaf spring is in contact with a cursor. Alternatively, another mechanism, such as a sensor, may be used so as to detect the width of the sheets in the sheet cassette.

The above embodiment concerns the situation where the image forming section 16 forms a color image constructed from yellow, magenta, cyan, and black images. However, the present invention is not limited to such an embodiment, and may, for example, alternatively be applied to a situation where a monochrome image constructed only from a black image is formed.

The above embodiment concerns the situation where the fixing roller 40 includes two heaters 42a and 42b, and the area of the fixing roller 40 to be heated is controlled by turning either of the two on. However, the present invention is not limited to such an embodiment. The fixing roller 40 may alternatively, for example, include a single heater. In that situation, the area of the fixing roller 40 to be heated may be controlled by selecting the area of the single heater to be turned on from, for example, the following: only a central area or both the central area and end areas.

The above embodiment concerns the situation where the two heaters 42a and 42b are provided inside the fixing roller 40. However, the present invention is not limited to such an embodiment. The heaters 42a and 42b may alternatively be provided outside the fixing roller 40.

The above embodiment concerns the situation where the detector 45 detects the width of the sheets in the sheet cassette. However, the present invention is not limited to such an embodiment. The sheet feeder 23 may alternatively, for example, include a manual feed tray and the width of the sheets placed on the manual feed tray may be detected.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image forming apparatus comprising:
an image forming unit that forms an image on a sheet;
a sheet feeder that feeds the sheet to the image forming unit;
a detector that detects a width of the sheet;
a setting unit that is operated by a user to input a width and a length of a nonstandard-size sheet;
a determination unit that determines whether the width of the nonstandard-size sheet detected by the detector and the width of the nonstandard-size sheet inputted by the user differ from each other, when the image is printed on the nonstandard-size sheet; and
a controller that controls the image forming unit to form the image, based on the width of the sheet detected by the detector and the length of the sheet inputted by the user to the setting unit, when the determination unit determines that the detected width and the inputted width differ from each other.

2. The image forming apparatus according to claim 1, wherein the image forming unit comprises a fixing roller that fixes the image onto the sheet, the fixing roller includes a first heating unit that heats a part of an area of the fixing roller and a second heating unit that heats a larger area of the fixing roller than the part of the area, and the controller controls where the fixing roller is heated using the first and second heating unit, based on the width of the sheet detected by the detector.

3. The image forming apparatus according to claim 2, wherein:
the first heating unit heats a central area of the fixing roller in a longitudinal direction of the fixing roller, and
the second heating unit heats the entirety of the fixing roller in the longitudinal direction of the fixing roller.

4. The image forming apparatus according to claim 1,
wherein the sheet feeder comprises:
a first sheet cassette that houses standard-size sheets; and
a second sheet cassette that houses nonstandard-size sheets.

5. The image forming apparatus according to claim 4,
wherein the first and second sheet cassettes include the detector respectively.

6. The image forming apparatus according to claim 1,
wherein the detector detects the width of the sheet by reading a resistance of a variable resistor.

7. A method of forming an image comprising the steps of:
feeding a sheet to an image forming unit;
forming an image on the sheet;
detecting a width of the sheet that the image forms;
inputting a width and a length of a nonstandard-size sheet that the image forms;
determining whether the detected width of the nonstandard-size sheet and the inputted width of the nonstandard-size sheet differ from each other, when the image is printed on the nonstandard-size sheet; and
controlling the image forming unit, based on the detected width of the sheet and the inputted length of the sheet, when the detected width and the inputted width differ from each other.

8. A method of forming an image comprising the steps of:
feeding a sheet to an image forming unit;
forming an image on the sheet;
detecting a width of the sheet that the image forms;
inputting a width and a length of a nonstandard-size sheet that the image forms; and
determining whether the detected width of the nonstandard-size sheet and the inputted width of the nonstandard-size sheet differ from each other, when the image is printed on the nonstandard-size sheet, and if so, forming an image based on the detected width of the sheet.
